(19) United States
(12) Patent Application Publication
(10) Pub. No.: US 2026/0193415 A1
(43) Pub. Date: Jul. 9, 2026

(54) DEPOLYMERIZATION OF SILICONE POLYMERS TO OBTAIN ORGANOPOLYSILOXANES

(71) Applicants: ELKEM SILICONES FRANCE SAS, LYON (FR); UNIVERSITÉ CLAUDE BERNARD LYON 1, VILLEURBANNE (FR); CENTRE NATIONAL DE LA RECHERCHE SCIENTIFIQUE, PARIS (FR); INSTITUT NATIONAL DES SCIENCES APPLIQUEES DE LYON, VILLEURBANNE (FR); UNIVERSITE JEAN MONNET, SAIN-ETIENNE (FR)

(72) Inventors: Aurelie BOULEGUE-MONDIERE, LYON (FR); Nicolas DURAND, TERNAY (FR); Daniel PORTINHA DE ALMEIDA, FONTAINES SUR SAONE (FR); Etienne FLEURY, SOUCIEU EN JARREST (FR); Pierre-Antoine FORENS, BRUGES (FR); Fabien DUPIN, Alix (FR)

(21) Appl. No.: 19/121,876

(22) PCT Filed: Oct. 12, 2023
(86) PCT No.: PCT/FR2023/000153

§ 371 Date: Apr. 17, 2025

(30) Foreign Application Priority Data
Oct. 17, 2022 (FR) FR2210651

(51) Int. Cl. C08G 77/08; C08J 11/28

(52) U.S. Cl. CPC C08G 77/08; C08J 11/28; C08J 2383/06

(57) ABSTRACT

Described herein is a method of reusing, reprocessing or recycling silicone polymers. More precisely, a method is described for preparing organopolysiloxanes OR by a depolymerization reaction of at least one silicone S in the presence of an acid catalyst and at least one chain blocker Bc having at least one siloxane function. The organopolysiloxanes OR can subsequently be used in polymerization reactions or directly in various formulations.

### TECHNICAL FIELD

The present invention generally relates to the reuse, the reprocessing or the recycling of silicone polymers. More specifically, the process of the present invention relates to the depolymerization of silicone polymers to obtain organopolysiloxanes OR of lower molecular weight which can be used subsequently in polymerization reactions or directly in various formulations.

### Technological Background

A major societal and industrial challenge of the coming years is the ecological transition. Thus, from an economic viewpoint, the “linear” (take-make-use-dispose) economic model must be replaced eventually by a circular model.

A circular economy describes an economic system based on models which replace the “end-of-life” product concept with the reduction, alternative reuse, recycling and recovery of these materials in production/distribution and consumption procedures, in order to achieve sustainable development for the benefit of current and future generations.

With an ever-growing increase in the silicone market and the expansion of the applications of such materials, the recycling of used silicone products is a major challenge in the silicone industry. Recycling silicone could reduce emissions of gases (CO, CO₂) relating to the silicone industry by 75% and silicone waste by 65%.

Furthermore, cyclic silicones or organopolysiloxanes, such as octamethylcyclotetrasiloxane (D4) and decamethylcyclopentasiloxane (D5) are and will be subject to restrictions on their use. Besides the fact that these cyclic compounds present environmental risks due to their non-biodegradability, they also suspected of being endocrine disruptors and potentially carcinogenic.

In this way, in 2018, European regulations limited the content of D4 and D5 to a content of 0.1% by weight in rinse-off cosmetic products. These regulations will shortly be adopted for other cosmetic products and also in other fields of applications of silicones.

Therefore, there is a need to provide processes for providing silicone products that are free of cyclic silicones or at least have a low content thereof.

In the prior art, the depolymerization of described by the organopolysiloxanes has been implementation of various processes.

In 2002, the content of patent application JP 2002348407A disclosed a process for chemically transforming a silicone product such as a silicone resin or silicone mold to linear polysiloxane. However, this process requires a large amount of acid catalyst, 12%, and the product obtained is in a mixture with cyclic compounds, formed by a back-cleavage reaction. This reaction is commonly known as a back-biting reaction.

More recently, in 2020, patent application US20200377686 described a process for recycling silicones (silicone oils, resins) by chemical transformation in order to obtain an α, ω-diacetoxypolydimethylsiloxane. However, this process requires heating the reaction medium and being placed in an excess of acetic anhydride.

Furthermore, the α, ω-diacetoxypolydimethylsiloxane can subsequently be chemically modified in order to obtain a polydimethylsiloxane having hydroxy or acetoxy end groups that can be used in adhesive compositions or in sealing products.

In 2022, patent application US2022119617 described a similar process. The α, ω-diacetoxypolydimethylsiloxane obtained is reused to obtain a α, ω-diisopropoxypolydimethylsiloxane or else a polydimethylsiloxane-polyoxyalkylene block polymer.

There is therefore an interest in providing an alternative process for depolymerization of silicones to give organopolysiloxanes that can be reused directly for subsequent formulations. There is notably an interest in providing a catalyst system for implementing this depolymerization at lower temperatures, limiting the amount of catalyst used and implementing a robust, selective and flexible process. There is also an interest in being able to reliably control the molecular weight of the products formed. This possibility makes it possible to increase the prospects for use and applications of such polymers.

### SUMMARY OF THE INVENTION

One objective of the present application is therefore to provide a process for depolymerization of silicones that makes it possible to control the molecular weight of the final product while varying the chemical nature of the end groups.

Another objective of the present application is to provide a catalyst system for implementing this process.

Another objective of the present application is to provide a simple, non-hazardous catalyst system that is compatible with industrialization of the process.

Another object of the present application is to provide a process that is satisfactory from an industrial viewpoint and which is in line with green chemistry.

Another objective of the present application is to obtain, on conclusion of this process, an organopolysiloxane OR having a low content of cyclic organopolysiloxane.

Yet other objectives will become apparent on reading the following description of the invention.

Surprisingly, the applicant has developed a catalyst system which meets these expectations. Thus, the present invention relates a to process for preparing organopolysiloxanes OR, by a reaction for depolymerization of at least one silicone S in the presence of an acid catalyst chosen from benzenesulfonic acid derivatives of formula (VIa), alone or as mixtures:

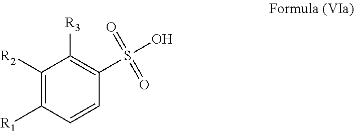

either R₁ and R₂ represent a hydrogen atom and R₃=CₙH₂ₙ₊₁ where 5≤n≤20, preferably 10≤n≤20,
or R₁ and R₃ represent a hydrogen atom and R₂=CₙH₂ₙ₊₁ where 5≤n≤20, preferably 10≤n≤20,
or else R₂ and R₃ represent a hydrogen atom and R₁=CₙH₂ₙ₊₁ where 5≤n≤20, preferably 10≤n≤20, and of at least one chain blocker Bc having at least one siloxane function.

In this case, the acid catalyst and the chain blocker Bc make it possible, during the depolymerization reaction, to control the molecular weight of the final product while making it possible to vary the chemical nature of the end groups.

### DETAILED DESCRIPTION OF THE INVENTION

Silicones, otherwise known as organopolysiloxanes, are polymer materials comprising alternating silicon and oxygen atoms with various organic radicals bonded to the silicon.

In the context of the present invention, a silicone or silicone product or silicone polymer or organopolysiloxane is understood to mean polymers comprising a siloxane (Si—O—Si) backbone containing alternating silicon and oxygen atoms with various organic radicals bonded to the silicon. These silicone polymers may be liquid or solid, depending on the molecular weight and the degree of crosslinking.

The silicones S of the invention may be of any type, for example linear organopolysiloxanes O such as oils gums, or branched organopolysiloxanes O, for example resins, crosslinked organopolysiloxanes such as gels or elastomers, or mixtures of such compounds.

The organopolysiloxane O may notably be an oil, and preferably has a dynamic viscosity of between 10 000 and 600 000 mPa·s at 25° C., preferably between 30 000 and 600 000 mPa·s at 25° C.

All the viscosities referred to herein correspond to a dynamic viscosity value at 25° C. referred to as “Newtonian”, i.e. the dynamic viscosity which is measured, in a manner known per se, with a Brookfield viscometer at a sufficiently low shear rate gradient for the measured viscosity to be independent of the rate gradient.

The term gum is conventionally used for organopolysiloxane compounds with viscosities conventionally greater than 600 000 mPa·s, which corresponds to a molecular weight of greater than 300 000 g/mol.

These organopolysiloxanes O may comprise one or more functional units such as:
OH;
H;
alkenyl notably comprising from 2 to 6 carbon atoms, preferably vinyl;
O-Alk with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl;
(O-Alk)ₓ with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x representing an integer between 2 and 200;
a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched.

Preferably, the functional units are chosen from:
OH;
H;
alkenyl notably comprising from 2 to 6 carbon atoms, preferably vinyl;
a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched.

Preferably, the organopolysiloxanes O may comprise one or more functional units such as H, OH, alkenyl (preferably vinyl), aryl or cyclic amine, as defined above. The organopolysiloxanes O may be partially crosslinked. The organopolysiloxanes O may notably be spent organopolysiloxanes which have been used, for example, as heat transfer fluids and which it would be advisable to recycle, the process of the invention thus making it possible to generate organopolysiloxanes OR which will then be able to be used directly in industrial processes. In the case where spent organopolysiloxanes O are used, the organopolysiloxane may thus contain other elements such as additives, pigments, etc. The inventors have shown that it was possible to carry out the depolymerization reaction and the formation of organopolysiloxanes OR under such conditions.

According to one embodiment of the invention, the organopolysiloxane O comprises:
at least 500, preferably at least 700, siloxy units of formula (I):

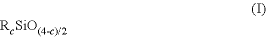

wherein
R, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
or an aryl group comprising from 6 to 10 carbon atoms, preferably phenyl,
and c=0, 1, 2 or 3;
and optionally one or more units of formula (II):

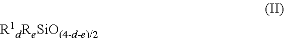

wherein
R is as defined above;
R₁, which may be identical or different, represents:
   an alkenyl group comprising from 2 to 6 carbon atoms, preferably vinyl,
   a hydroxy group (OH),
   an (O-Alk) group with Alk representing an alkyl group comprising from 1 to 15 carbon atoms, preferably from 1 to 12 carbon atoms, preferably from 1 to 10 carbon atoms, preferably from 1 to 5 carbon atoms, preferably OCH₃ or OC₂H₅,
   an (O-Alk)ₓ group with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched, or
   a hydrogen;
d=1, 2 or 3, preferably d=1 or 2, more preferentially d=1; e=0, 1 or 2; and the sum d+e=1, 2 or 3.

It is understood in the above formulae that, if several R groups are present or if several R₁ groups are present, they may be identical to or different from one another.

Preferably, in the above formulae, R₁, which may be identical or different, represents:
an alkenyl group comprising from 2 to 6 carbon atoms, preferably vinyl,
a hydroxy group (OH),
a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched, or
a hydrogen.

In the present invention:
an “M” siloxy unit represents a siloxy unit of formula Y₃SiO_{1/2},
a “D” siloxy unit represents a siloxy unit of formula Y₂SiO_{2/2},
a “T” siloxy unit represents a siloxy unit of formula YSiO_{3/2},
a “Q” siloxy unit represents a siloxy unit of formula SiO_{4/2},
   the Y symbols being R or R₁.

The organopolysiloxane O may optionally be linear or branched and notably may comprise T and Q units.

According to a preferential embodiment, the organopolysiloxane O is chosen from the compounds of formula (III):

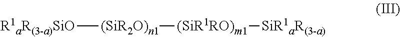

wherein:
R, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl, or
   an aryl group comprising from 6 to 10 carbon atoms, preferably phenyl;
R₁, which may be identical or different, represents:
   an alkenyl group comprising from 2 to 6 carbon atoms, preferably vinyl,
   a hydroxy group (OH),
   an (O-Alk) group with Alk representing an alkyl group comprising from 1 to 15 carbon atoms, preferably from 1 to 12 carbon atoms, preferably from 1 to 10 carbon atoms, preferably from 1 to 5 carbon atoms, preferably OCH₃ or OC₂H₅,
   an (O-Alk)ₓ group with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200,
   a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched, or
   a hydrogen;
a is an integer and represents 0, 1, 2 or 3, preferably 0, 1 or 2, more preferentially 0 or 1;
   n1 represents an integer between 500 and 10 000, preferably between 1000 and 5000, more preferably between 500 and 5000, more preferentially between 600 and 2000;
   m1 represents an integer between 0 and 100, preferably between 0 and 50, more preferentially between 0 and 30, preferably m=0.

Particularly preferably, the organopolysiloxane O is a compound of formula (III) in which R₁, which may be identical or different, represents:
an alkenyl group comprising from 2 to 6 carbon atoms, preferably vinyl,
a hydroxy group (OH),
a linear or branched alkyl group comprising from 1 to 10 carbon atoms, preferably from 1 to 5 carbon atoms, substituted with at least one fluorine atom, for example from 1 to 10 fluorine atoms, for example (C₁-C₅)alkyl-CF₃, the alkyl being linear or branched, or
a hydrogen.

Particularly preferably, the organopolysiloxane O is a compound of formula (III) in which R₁, which may be identical or different, represents:
CH₃, vinyl, H, (C₁-C₅)alkyl-CF₃ or OH.

Particularly preferably, the organopolysiloxane O is a compound of formula (III) in which:
R, which may be identical or different, represents CH₃ or phenyl, preferably CH₃;
R¹, which may be identical or different, represents:
   an alkenyl group comprising from 2 to 6 carbon atoms, preferably vinyl,
   a hydroxy group (OH),
   a linear or branched alkyl group comprising from 1 to 10 carbon atoms, preferably from 1 to 5 carbon atoms, optionally substituted with at least one fluorine atom, for example from 1 to 10 fluorine atoms, for example (C₁-C₅)alkyl-CF₃, the alkyl being linear or branched, or
   a hydrogen.

Particularly preferably, the organopolysiloxane O is a compound of formula (III) in which:
R, which may be identical or different, represents CH₃ or phenyl, preferably CH₃,
R¹, which may be identical or different, represents CH₃, vinyl, H, (C₁-C₅)alkyl-CF₃ or OH.

The silicones invention may also be of crosslinked silicone material type, for instance gels or elastomers. Crosslinked silicone materials are well known to those skilled in the art. These materials can notably be obtained by polycondensation, radical polymerization, thermal or UV-irradiated polyaddition. Silicone products have a multitude of applications. By way of example, they can be found in food applications such as baking molds, medical applications and in the pharmaceutical sector, for instance in baby bottle teats, catheters, implants or tubes for medical applications. In technical industrial applications, silicone is often used as a material for seals or membranes. In the automotive sector, t is used for hoses, cable sheathing or insulation, and as a damping material.

Silicone elastomers are crosslinked silicone materials comprising fillers, for instance silica, to obtain good mechanical properties. By varying the silicone oils, fillers and additives, and also the crosslinking method, silicone elastomers have different properties and colors. Silicone elastomers may be divided into three main groups that are well known to those skilled in the art.

High-temperature vulcanization (HTV) or heat-cured rubber (HCR) elastomers are silicone elastomers obtained from silicone compositions with a very high viscosity comprising silicone gums and fillers. They are vulcanized at high temperature, generally between 140° C. and 200° C. The crosslinking is either radical-mediated, catalyzed with peroxides, or obtained by an addition reaction in which platinum compounds are used as catalysts.

Liquid silicone rubbers (LSR) are silicone elastomers obtained from compositions comprising viscous silicone oils and fillers. Crosslinking occurs by an addition reaction at temperatures similar to those of HTVs, with crosslinking generally taking place much more rapidly.

The third group consists of silicones obtained by crosslinking silicone compositions at room temperature from silicone oils and fillers crosslinked by polycondensation or polyaddition reactions. These elastomers are known under the name room temperature vulcanization (RTV) silicone elastomer. These compositions are available in one-component and two-component systems.

In the process of the present application, a silicone S also means silicone-based materials, for example materials comprising at least 0.1% by weight of silicone relative to the total weight of silicone-based material. Conventionally, these materials can be found in silicone-coated textiles (airbags or synthetic leather) and silicone coatings (food-grade paper).

The silicone-based material may comprise up to 100% by weight of silicone, preferably up to 99.9% by weight of silicone relative to the total weight of silicone-based material. These silicone-based materials may also comprise additives or fillers such as dyes, silica, calcium carbonate, calcium oxide, celite, quartz, titanium oxide, cerium hydroxide, magnesium oxide, mica, etc.

According to one embodiment, the silicone S comprises silica, calcium carbonate, quartz, titanium oxide, magnesium oxide, mica and mixtures thereof.

In the context of the present invention, the number of moles of (Si—O) means the number of moles of (Si—O) bonds in the silicone S. In the case where the starting silicone Sis of unknown formula, notably in the case of formulated commercial products, it is possible to estimate the number of moles of (Si—O) bonds. Specifically, for formulated silicone elastomers, a person skilled in the art knows that the amount of filler is between 20% and 40% by weight, and thus, by estimating the amount of filler at an average of 30% by weight, this gives 70% by weight of silicone, enabling the number of moles of (Si—O) bonds to be calculated from the average molar mass of the repeating unit.

In the context of the present application, the term chain blocker Bc has at least one siloxane function.

In the process of the invention, the chain blocker Bc is represented by formula (IV):

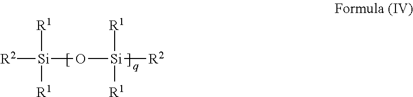

wherein:
R¹, which may be identical or different, represents:
   a linear or branched alkyl group comprising from 1 to 12 carbon atoms, preferably from 1 to 8 carbon atoms, optionally substituted with a heteroatom O, N, S or a halide,
   an alkenyl group comprising from 2 to 6 carbon atoms,
   a cycloalkyl group of from 5 to 10 carbon atoms, optionally substituted with a heteroatom O, N, S or a halide,
   a C₆-C₁₈ aryl group,
   a hydroxy group, or
   a hydrogen,
R², which may be identical or different, represents:
   an alkenyl group comprising from 2 to 6 carbon atoms, preferably vinyl,
   a hydroxy group (OH),
   a linear or branched alkyl group comprising from 1 to 12 carbon atoms, preferably from 1 to 5 carbon atoms, optionally substituted with at least one heteroatom 0, N, S or a halide such as a fluorine atom, for example 1 to 10 fluorine atoms, for example (C₁-C₅)alkyl-CF₃, the alkyl being linear or branched; or
   a hydrogen;
and q is an integer between 1 and 50, preferably between 1 and 20, more preferentially between 1 and 10.

In another embodiment, the chain blocker Bc is represented by formula (IV) wherein:
R¹, which may be identical or different, represents CH₃ or phenyl, preferably CH₃;
R², which may be identical or different, represents:
   an alkenyl group comprising from 2 to 6 carbon atoms, preferably vinyl,
   a hydroxy group (OH),
   a linear or branched alkyl group comprising from 1 to 12 carbon atoms, preferably from 1 to 5 carbon atoms, optionally substituted with at least one heteroatom 0, N, S or a halide such as a fluorine atom, for example 1 to 10 fluorine atoms, for example (C₁-C₅)alkyl-CF₃, the alkyl being linear or branched, or
   a C₆-C₁₈ aryl group, which is optionally substituted, or
   a hydrogen;
and q is an integer between 1 and 50, preferably between 1 and 20, more preferentially between 1 and 10.

Particularly preferably, the chain blocker BC is represented by formula (IV) wherein:
R¹, which are identical, represents CH₃,
R², which may be identical or different, represents:
   an alkenyl group comprising from 2 to 6 carbon atoms, preferably vinyl,
   a hydroxy group (OH),
   a linear or branched alkyl group comprising from 1 to 10 carbon atoms, preferably from 1 to 5 carbon atoms,
   a C₆-C₁₈ aryl group, which is optionally substituted, or
   a hydrogen,
and q is an integer between 1 and 20, preferably between 1 and 10, more preferentially between 1 and 5.

Other blockers having a siloxane function according to the invention are described in the book Chemistry and Technology of Silicones, published in 1968 by Academic Press, on page 264.

The chain blocker Bc may be in a solvent. This is particularly advantageous in order to solubilize it in the reaction medium. The solvent may notably be a nonpolar solvent such as an organic solvent of alkane or aromatic hydrocarbon type. Preferably, the solvent is chosen from n-hexane, n-heptane, n-decane, n-dodecane, isododecane, EXXSOL D60, xylene, toluene and mixtures thereof.

The amount of chain blocker Bc used in the process of the invention is at least 10⁻⁴ mol relative to the number of moles of (Si—O) bonds in the silicone S, preferably between 10⁻³ and 5×10⁻¹ mol, preferentially between 10⁻³ and 10⁻² mol, even more preferentially between 3×10⁻³ and 6×10⁻¹ mol, for example 5×10⁻³ mol relative to the moles of (Si—O) bonds in the silicone S.

These chain blockers enable the functionalization of the organopolysiloxane OR during the depolymerization reaction. Thus, it is possible to obtain organopolysiloxanes OR having for example Si-vinyl or Si—H functions.

In the process according to the invention, use may optionally be made of a mixture of various chain blockers. Thus, an organopolysiloxane OR which may have different functional groups at the chain end could be obtained.

In an alternative embodiment, the process of the invention may be carried out with no chain blocker Bc.

The acid catalyst used as catalyst in the process of the present invention is chosen from the group comprising Bronsted acids having a pKa of less than or equal to 2 such as trifluoromethanesulfonic acid, benzenesulfonic acid and its derivatives, alone or as mixtures.

Preferably, the acid catalyst is chosen from benzenesulfonic acid and its derivatives of formula (Va), alone or as mixtures:

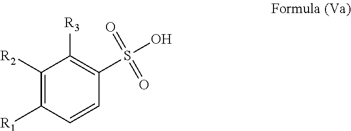

either R₁ and R₂ represent a hydrogen atom and R₃=CₙH₂ₙ₊₁ where 1≤n≤20,
or R₁ and R₃ represent a hydrogen atom and R₂=CₙH₂ₙ₊₁ where 1≤n≤20,
or else R₂ and R₃ represent a hydrogen atom and R₁=CₙH₂ₙ₊₁ where 1≤n≤20.

In one embodiment, the acid catalyst is chosen from benzenesulfonic acid and its derivatives of formula (Vb), alone or as mixtures:

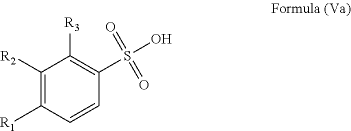

with R=H or CₙH₂ₙ₊₁ where 1≤n≤20.

More preferentially, the acid catalyst is chosen from benzenesulfonic acid derivatives of formula (VIa), alone or as mixtures:

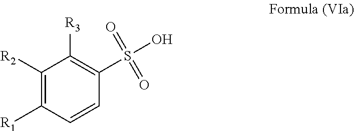

either R₁ and R₂ represent a hydrogen atom and R₃=CₙH₂ₙ₊₁ where 5≤n≤20, preferably 10≤n≤20,
or R₁ and R₃ represent a hydrogen atom and R₂═CₙH₂ₙ₊₁ where 5≤n≤20, preferably 10≤n≤20,
or else R₂ and R₃ represent a hydrogen atom and R₁=CₙH₂ₙ₊₁ where 5≤n≤20, preferably 10≤n≤20.

In one embodiment, the acid catalyst is chosen from benzenesulfonic acid derivatives of formula (VIb), alone or as mixtures:

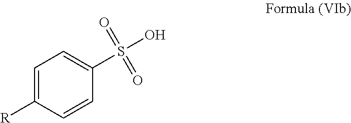

with R=CₙH₂ₙ₊₁ where 5≤n≤20, preferably 10≤n≤20.

It should be noted that the alkyl groups mentioned in the formulae (Va), (Vb), (VIa) and (VIb) may be primary, secondary or tertiary alkyl groups.

Even more preferentially, the acid catalyst is HDBS also known under the name 4-dodecylbenzenesulfonic acid (CAS 121-65-3).

Alternatively, the acid catalyst is chosen from Bronsted acids having a pKa of less than or equal to −2 such as perfluoroalkane acids, for example trifluoromethanesulfonic acid (triflic acid), pentafluoroethanesulfonic acid, heptafluoropropanesulfonic acid, or chlorinated derivatives, alone or as mixtures.

Depending on the nature of the acid catalyst, it is possible to solubilize it in a solvent. Preferably, the solvent is a nonpolar solvent. The solvent may notably be an organic solvent of alkane or aromatic hydrocarbon type. Preferably, the solvent is identical to the one chosen during the depolymerization reaction. Thus, the solvent may notably be an organic solvent of alkane or aromatic hydrocarbon type.

The amount of acid catalyst used in the process of the invention is between 0.001% and 3% by weight relative to the weight of silicone S, preferably between 0.05% and 1%, more preferentially between 0.1% and 1%, for example 0.4% by weight relative to the weight of silicone S.

In one embodiment, the organopolysiloxanes OR may have, at the chain end, functional groups derived from the chain blocker such as vinyl functions, Si—H functions, or Si-aryl functions for example.

Depending on the implementation of the process, they may be identical or different. The organopolysiloxane OR as defined above may optionally comprise T and Q units.

According to one embodiment of the invention, the organopolysiloxane OR comprises:
at least 2 siloxy units of formula (VII):

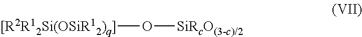

wherein
R, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl,
c=1, 2 or 3;
R¹, which may be identical or different, represents:
   a linear or branched alkyl group comprising from 1 to 12 carbon atoms, preferably from 1 to 8 carbon atoms, optionally substituted with a heteroatom O, N, S or a halide,
   an alkenyl group comprising from 2 to 6 carbon atoms,
   a cycloalkyl group of from 5 to 10 carbon atoms, optionally substituted with a heteroatom O, N, S or a halide,
   a C₆-C₁₈ aryl group,
   a hydroxy group, or
   a hydrogen,
R², which may be identical or different, represents:
   an alkenyl group comprising from 2 to 6 carbon atoms, preferably vinyl,
   a hydroxy group (OH),
   a linear or branched alkyl group comprising from 1 to 12 carbon atoms, preferably from 1 to 5 carbon atoms, optionally substituted with at least one heteroatom 0, N, S or a halide such as a fluorine atom, for example 1 to 10 fluorine atoms, for example (C₁-C₅)alkyl-CF₃, the alkyl being linear or branched,
   an optionally substituted C₅-C₁₀ cycloalkyl group,
   an optionally substituted C₆-C₁₈ aryl group, or
   a hydrogen;
q is an integer between 1 and 50, preferably between 1 and 20, more preferentially between 1 and 10, and one or more units of formula (VIII), preferably from 10 to 1500 units, preferentially from 50 to 1000 units and even more preferentially from 100 to 500 units:

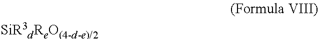

wherein:
R, which may be identical or different, is as defined above;
R³, which may be identical or different, is as defined above by the R¹ group;
and d=0, 1, 2, preferably d=0 or 1; e=1, 2 or 3; and the sum d+e=1, 2 or 3.

Preferably, in the above formulae, R³, which may be identical or different, represents:
an alkenyl group comprising from 2 to 6 carbon atoms, preferably vinyl;
a hydroxy group (OH);
a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched;
a hydrogen.

According to one embodiment of the invention, the organopolysiloxane OR may be a compound of formula (IX):

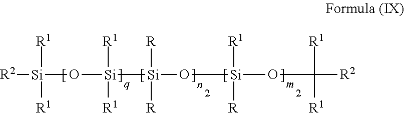

wherein
R, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl,
R¹, which may be identical or different, represents:
   an alkenyl group comprising from 2 to 6 carbon atoms, preferably vinyl,
   a hydroxy group (OH),
   an (O-Alk) group with Alk representing an alkyl group comprising from 1 to 15 carbon atoms, preferably from 1 to 12 carbon atoms, preferably from 1 to 10 carbon atoms, preferably from 1 to 5 carbon atoms, preferably OCH₃ or OC₂H₅,
   an (O-Alk)ₓ group with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x represents an integer between 2 and 200, or
   a hydrogen;
R², which may be identical or different, represents:
   an alkenyl group comprising from 2 to 6 carbon atoms, preferably vinyl,
   a hydroxy group (OH),
   a linear or branched alkyl group comprising from 1 to 12 carbon atoms, preferably from 1 to 5 carbon atoms, optionally substituted with at least one heteroatom 0, N, S or a halide such as a fluorine atom, for example 1 to 10 fluorine atoms, for example (C₁-C₅)alkyl-CF₃, the alkyl being linear or branched,
   an optionally substituted C₅-C₁₀ cycloalkyl group,
   an optionally substituted C₆-C₁₈ aryl group, or
   a hydrogen;
q is an integer between 1 and 50, preferably between 1 and 20, more preferentially between 1 and 10;
n₂ represents an integer between 10 and 1500, preferably between 10 and 1000, preferably between 50 and 1000, more preferentially between 100 and 500;
m₂ represents an integer between 0 and 100, preferably between 0 and 50, more preferentially between 0 and 30, preferably m=0.

According to a preferred embodiment of the invention, the organopolysiloxane OR is a compound of formula (IX):
wherein,
R, which may be identical or different, represents CH₃ or phenyl, preferably CH₃;
R¹, which may be identical or different, represents:
   an alkenyl group comprising from 2 to 6 carbon atoms, preferably vinyl,
   a hydroxy group (OH),
   a linear or branched alkyl group comprising from 1 to carbon atoms, preferably from 1 to 5 carbon atoms, substituted with at least one fluorine atom, for example 1 to 10 fluorine atoms, for example (C₁-C₅)alkyl-CF₃, the alkyl being linear or branched, or
   a hydrogen;
R², which may be identical or different, represents:
   an alkenyl group comprising from 2 to 6 carbon atoms, preferably vinyl,
   a hydroxy group (OH),
   a linear or branched alkyl group comprising from 1 to 12 carbon atoms, preferably from 1 to 5 carbon atoms, optionally substituted with at least one heteroatom 0, N, S or a halide such as a fluorine atom, for example 1 to 10 fluorine atoms, for example (C₁-C₅)alkyl-CF₃, the alkyl being linear or branched,
   an optionally substituted C₅-C₁₀ cycloalkyl group,
   an optionally substituted C₆-C₁₈ aryl group, or
   a hydrogen;
q is an integer between 1 and 50, preferably between 1 and 20, more preferentially between 1 and 10;
n₂ represents an integer between 10 and 1500, preferably between 10 and 1000, preferably between 50 and 1000, more preferentially between 100 and 500;
m₂ represents an integer between 0 and 100, preferably between 0 and 50, more preferentially between 0 and 30, preferably m=0.

According to a particularly preferred embodiment of the invention, the organopolysiloxane OR of the invention is a compound of formula (IX) wherein:
R, which may be identical or different, represents CH₃ or phenyl, preferably CH₃,
R¹, which may be identical or different, represents CH₃, vinyl, H, (C₁-C₅)alkyl-CF₃ or OH;
R², which may be identical or different, represents:
   an alkenyl group comprising from 2 to 6 carbon atoms, preferably vinyl,
   a hydroxy group (OH),
   a linear or branched alkyl group comprising from 1 to carbon atoms, preferably from 1 to 5 carbon atoms,
   an optionally substituted C₆-C₁₈ aryl group, or
   a hydrogen;
q is an integer between 1 and 20, preferably between 1 and 10, more preferentially between 1 and 5;
n₂ represents an integer between 10 and 1500, preferably between 10 and 1000, preferably between 50 and 1000, more preferentially between 100 and 500;
m₂ represents an integer between 0 and 100, preferably between 0 and 50, more preferentially between 0 and 30, preferably m=0.

In one embodiment, the organopolysiloxane OR of the invention is a compound of formula (X) wherein:

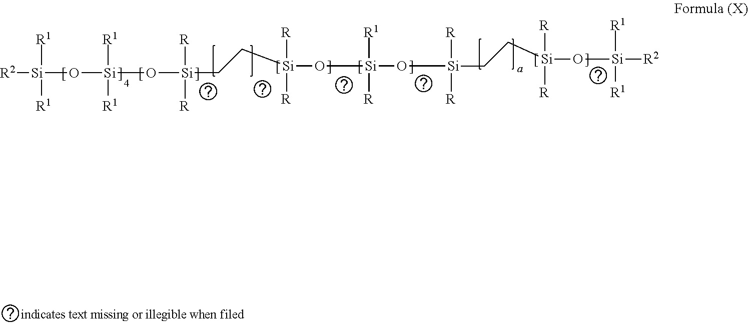

R, which may be identical or different, represents:
   an alkyl group comprising from 1 to 15 carbon atoms, preferably from 1 to 12 carbon atoms, preferably from 1 to 10 carbon atoms, preferably from 1 to 5 carbon atoms, preferably methyl,
   an aryl group comprising from 6 to 10 carbon atoms, preferably phenyl,
R¹, which may be identical or different, represents:
   an alkenyl group comprising from 2 to 6 carbon atoms, preferably vinyl,
   a hydroxy group (OH),
   an (O-Alk) group with Alk representing an alkyl group comprising from 1 to 15 carbon atoms, preferably from 1 to 12 carbon atoms, preferably from 1 to 10 carbon atoms, preferably from 1 to 5 carbon atoms, preferably OCH₃ or OC₂H₅,
   an (O-Alk)ₓ group with Alk representing an alkyl group comprising from 1 to 15 carbon atoms, preferably from 1 to 12 carbon atoms, preferably from 1 to 10 carbon atoms, preferably from 1 to 5 carbon atoms, preferably methyl, and x representing an integer between 2 and 200,
   a linear or branched alkyl group comprising from 1 to 10 carbon atoms, preferably from 1 to 5 carbon atoms, substituted with at least one fluorine atom, for example 1 to 10 fluorine atoms, for example (C₁-C₅)alkyl-CF₃, the alkyl being linear or branched,
   a hydrogen, or
   a —CH₂CH₂ (R³SiO)ₙ₃ group with R as defined above and n3 representing an integer between 0 and 1000, preferably between 0 and 500, more preferentially between 0 and 200;
R², which may be identical or different, represents:
   an alkenyl group comprising from 2 to 6 carbon atoms, preferably vinyl,
   a hydroxy group (OH),
   a linear or branched alkyl group comprising from 1 to 12 carbon atoms, preferably from 1 to 5 carbon atoms, optionally substituted with at least one heteroatom O, N, S or a halide such as a fluorine atom, for example 1 to 10 fluorine atoms, for example (C₁-C₅)alkyl-CF₃, the alkyl being linear or branched,
   an optionally substituted C₅-C₁₀ cycloalkyl group,
   an optionally substituted C₆-C₁₈ aryl group, or
   a hydrogen;
q is an integer between 1 and 50, preferably between 1 and 20, more preferentially between 1 and 10;
n₂ represents an integer between 10 and 1500, preferably between 10 and 1000, preferably between 50 and 1000, more preferentially between 100 and 500;
m₂ represents an integer between 0 and 100, preferably between 0 and 50, more preferentially between 0 and 30, preferably m=0;
n₃ represents a different or identical integer between 0 and 1000, preferably 0 and between 500, more preferentially between 0 and 200;
a represents a different or identical integer equal to 0 or 1.

Within the meaning of the present invention, the degree of polymerization is understood to mean the integer representing the number of siloxy repeating units.

According to one embodiment of the process of the invention, the organopolysiloxane OR thus obtained has a degree of polymerization which is at least halved compared to the degree of polymerization of the silicone S introduced, preferably which is at least divided by three, preferentially at least divided by five compared to the degree of polymerization of the silicone S introduced.

According to one embodiment of the process of the invention, the organopolysiloxane OR thus obtained has a degree of polymerization which is at least divided by ten compared to the degree of polymerization of the silicone S introduced.

Within the meaning of the present invention, the weight-average molecular weight and the number-average molecular weight, respectively denoted M_{w} and Mₙ, of the various organopolysiloxanes OR may be determined by size exclusion chromatography (SEC) in the presence of polystyrene standards in a solvent such as toluene at 40° C.

According to one embodiment of the process of the invention, the organopolysiloxane OR thus obtained has a weight-average molecular weight M_{w} which is at least halved compared to the weight-average molecular weight of the silicone S introduced, preferably which is at least divided by three, preferentially at least divided by five compared to the weight-average molecular weight M_{w} of the silicone S introduced.

It is also conceivable, according to one embodiment of the process of the invention, for the organopolysiloxane OR thus obtained to have a weight-average molecular weight M_{w} which is at least divided by ten compared to the weight-average molecular weight of the silicone S introduced, or else at least divided by fifteen compared to the weight-average molecular weight M_{w} of the silicone S introduced.

According to one embodiment of the process of the invention, the organopolysiloxane OR of the invention is characterized in that its weight-average molecular weight M_{w} may be between 500 and 300 000 g/mol, preferably between 1000 and 150 000 g/mol, preferentially between 1000 and 100 000 g/mol, even more preferentially between 5000 and 40 000 g/mol.

According to one embodiment of the process of the invention, the organopolysiloxane OR thus obtained has a number-average molecular weight Mₙ which is at least halved compared to the number-average molecular weight of the silicone S introduced, preferably which is at least divided by three, preferentially at least divided by five compared to the number-average molecular weight Mₙ of the silicone S introduced.

It is also conceivable, according to one embodiment of the process of the invention, for the organopolysiloxane OR thus obtained to have a number-average molecular weight Mₙ which is at least divided by ten compared to the number-average molecular weight of the silicone S introduced, or else at least divided by fifteen compared to the number-average molecular weight Mₙ of the silicone S introduced.

According to one embodiment of the process of the invention, the organopolysiloxane OR of the invention is characterized in that its number-average molecular weight Mₙ is between 500 and 300 000 g/mol, preferably between 1000 and 150 000 g/mol, preferentially between 1000 and 70 000 g/mol, even more preferentially between 2500 and 30 000 g/mol.

According to one embodiment of the process of the invention, the organopolysiloxane OR of the invention is characterized in that its dynamic viscosity is between 100 and 100 000 mPa·s at 25° C., preferably between 1000 and 80 000 mPa·s at 25° C., even more preferentially between 10 000 and 70 000 mPa·s at 25° C.

In one embodiment, the organopolysiloxane of the invention OR has an amount of (Si—O) bonds at the chain end of less than or equal to 15%, preferably less than or equal to 10%, preferentially less than or equal to 5% and even more preferentially less than or equal to 1% relative to the total amount of silicon atoms at the chain end of the organopolysiloxane of the invention OR.

In the context of the present application, the weight percentage of D₄ in the products obtained according to the process of the present invention may be measured via quantitative ²⁹Si NMR spectra. Alternatively, the weight percentage of D₄ in the products obtained according to the process of the present invention could be measured via the chromatograms from a size exclusion chromatography (SEC) analysis.

Within the meaning of the present invention, the term cyclic organopolysiloxanes refers to the compounds of formula (XI):

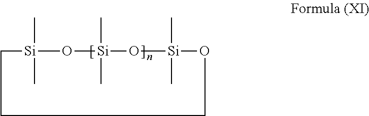

wherein n represents a natural number between 1 and 5.

Generally, within the meaning of the present invention, the cyclic organopolysiloxanes consist of the compounds of formula (XI) where n is equal to 2 or 3 or 4.

In other words, octamethylcyclotetrasiloxane (D₄), decamethylcyclopentasiloxane (D₅), dodecamethylcyclohexasiloxane (D₆) or mixtures thereof.

In one embodiment, the process according to the invention is characterized in that the content of cyclic organopolysiloxanes is less than 5%, preferably less than or equal to 3%, preferentially less than or equal to 2% and even more preferentially less than or equal to 1.5% relative to the total weight of the organopolysiloxanes of the invention OR.

In one embodiment, the process according to the invention is characterized in that the content of octamethylcyclotetrasiloxane (D₄) is less than 5%, preferably less than or equal to 38, preferentially less than or equal to 2% and even more preferentially less than or equal to 1.5% relative to the total weight of the organopolysiloxanes of the invention OR.

Preferably, the process of the invention is carried out in a solvent. The process of the invention is preferentially carried out in a nonpolar solvent. The solvent may notably be an organic solvent of alkane or aromatic hydrocarbon type.

Preferably, the solvent is chosen from n-hexane, n-heptane, n-decane, n-dodecane, isododecane, EXXSOL D60, xylene, toluene and mixtures thereof.

In one embodiment, the process of the invention is characterized in that the weight ratio, weight of silicone S to weight of solvent used, is between 0.01 and 15, preferably between 0.1 and 5, preferentially between 0.1 and 2.

In one embodiment, the process of the invention is characterized in that the depolymerization reaction takes place without solvent.

This embodiment is particularly advantageous since it makes it possible to dispense with the use of solvent, and with the treatment or recycling thereof once spent, while obtaining satisfactory results when carrying out the process of the present invention.

Advantageously and preferably, the reaction is carried out at a temperature between 0° C. and 100° C., preferably between 0° C. and 50° C., more preferentially between 10° C. and 35° C., for example at room temperature.

According to the process of the invention, the reaction time is between 2 and 72 h, preferably between 5 and 24 h, more preferentially between 8 and 24 h, for example 24 h.

A person skilled in the art will know how to adapt these parameters depending on the nature of the reactors and species used.

The process according to the invention may further comprise a step of neutralizing the acid catalyst. This neutralization step makes it possible to prevent the appearance of side reactions and to deactivate the acid catalyst.

Advantageously, this neutralization step is carried out by adding a base to the reaction medium or by thermal degradation of the acid catalyst.

According to the process of the invention, the base is chosen from amines, hydroxides of alkali metals, hydroxides of alkaline-earth metals, carbonates, hydrogen carbonates, and mixtures thereof.

Preferably, the base is chosen from the group of tertiary amines or hydrogen carbonates.

Alternatively, the neutralization step is carried out by “thermal degradation”.

The term “thermal degradation” is understood to mean heating to a temperature above 120° C. for a period of between 10 minutes and 3 h. A person skilled in the art will know how to adapt the operating conditions in order to optimize this thermal degradation step. This step makes it possible to degrade the catalyst and to stop the depolymerization reaction.

The process according to the invention may further comprise a filtration step in order to extract the neutralized and/or the excess base from the reaction medium. This step may also make it possible to extract any fillers resulting from the silicone S depolymerized according to the process of the present invention. A person skilled in the art will know how to adapt the filtration method according to the size of the reactor and the species used in the process according to the invention.

According to a preferred embodiment of the invention, the process of the present invention comprises the following three steps:
1) carrying out the process for preparing organopolysiloxanes OR, by a reaction for depolymerization of at least one silicone S in the presence of an acid catalyst and of at least one chain blocker Bc having at least one siloxane function;
2) neutralizing the acid catalyst mentioned in the preceding step by adding a base to the reaction medium or by thermal degradation of the acid catalyst; and 3) filtering the reaction medium obtained on conclusion of step 2.

The present application also relates to the use of the organopolysiloxanes OR obtained according to the process of the present invention as an ingredient that can be used directly in various silicone formulations of use in fields such as cosmetics, household products, motor vehicles, energy.

The organopolysiloxanes OR derived from silicone S as described in detail above in the present application can be used again in various formulations in order to prepare a new silicone S.

Thus, the present application also relates to the use of the organopolysiloxanes OR obtained by the process of the present invention for the preparation of silicone S, for example for the preparation of silicone oils, resins, gums, gels or elastomers.

The present application also relates to a process for preparing silicone, notably silicone oils, resins or gums, comprising the following steps:
1) carrying out the process for preparing organopolysiloxanes OR according to the invention;
2) preparing silicone S, notably oils, resins, gums or elastomers, from the organopolysiloxanes OR obtained in step 1).

In one embodiment, the process for preparing silicone S is characterized in that step 2 is carried out by a polyaddition or polycondensation reaction, of cationic mechanism or of radical mechanism.

Step 2 may notably consist in producing liquid silicone rubbers (LSR), high-temperature vulcanization (HTV) silicone elastomers or room temperature vulcanization (RTV) silicone elastomers.

According to another embodiment, step 2 may notably consist in preparing silicones S of use in the field of cosmetics, health, household products, technical industrial formulations (seals, membranes, tubes), transportation such as motor vehicle or aviation transportation, or else in the energy field.

### EXAMPLES

### Silicones Used in the Examples:

In the following: Me=methyl;

### Silicone S1:

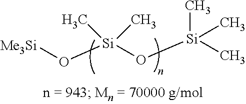

### Silicone S2:

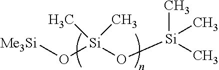

Mixture of three silicone oils where n=81, (Mₙ=6000 g/mol), n=943 (Mₙ=70 000 g/mol) and n=1080 (Mₙ=80 000 g/mol)

### Silicone S3:

The silicone S3 is an RTV2 gel formulated by ELKEM. This silicone was obtained by polyaddition reaction.

### Silicone S4:

A commercial silicone tube of unknown composition, cut into pieces.

### Silicone S5:

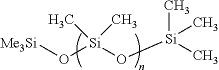

The silicone S5 is a PDMS gum, sold by ELKEM under the name BLUESIL™ FB Silicone Gum.

The acid catalyst is HDBS also known under the name 4-dodecylbenzenesulfonic acid (CAS 121-65-3).

The solvent used in the examples is a nonpolar solvent, preferably toluene or heptane.

### Chain Blockers Used in the Examples:

Chain blocker Bc1: divinyltetramethyldisiloxane (CAS 2627-95-4).
Chain blocker Bc2: hexamethyldisiloxane (CAS 107-46-0)
Chain blocker Bc3: tetramethyldisiloxane (CAS 3277-26-7)
Chain blocker Bc4:

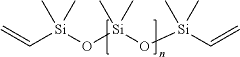

with n=13 (Mₙ=977 g/mol).

### Example 1: General Protocol of the Process

A silicone S and 120 ml of toluene are introduced into a 250-ml round-bottomed flask along with variable amounts of acid catalyst and chain blocker Bc. The reaction medium is placed at room temperature under stirring for a duration of 24 h. A large excess of inorganic or amine base is then added to the reaction medium. A sample is drawn off and analyzed by ¹H NMR and ²⁹Si NMR.

In the context of the examples described below, the weight percentage of D₄ relative to the total weight of the organopolysiloxane OR obtained according to the process of the present invention is measured by size exclusion chromatography (SEC) in the presence of polystyrene standards in a solvent such as toluene at 40° C.

Similarly, the number-average molecular weight, denoted Mₙ, of the various organopolysiloxanes according to the present invention OR is determined by the same method of size exclusion chromatography (SEC).

The value QBc will be found in the various tables exemplified below. This value expresses the number of moles of Bc relative to the moles of (Si—O) bonds in the silicone S.

### Example 2: Influence of the Nature of the Silicone S on the Process of the Invention

The protocol from example 1 is implemented with a silicone S (30 g, around 404 mmol of (Si—O) bonds in the silicone S for S1, S2, S3 and S5), HDBS (4400 ppm by weight, 0.132 g) as acid catalyst and Bc1 as chain blocker Bc. The reaction medium is placed at room temperature under stirring for a duration of 24 h. The silicone S4 is a commercial silicone tube of unknown composition, cut into pieces. In the remainder of this example, it will be considered that this tube is composed both of a significant amount of filler, 30%, and of an amount of silicone of 70%.

Thus, for 30 g of silicone tube, this test considers that there are 21 g of silicone S. 0.265 g of chain blocker Bc1 and 0.0925 g of HDBS were then introduced into the reaction medium.

The nature of the silicone S and the value QBc are given in the table below.

| | | | | Mₙ of the | Degree of |
|---|---|---|---|---|---|
| | | Chain | | product | polymerization |
| Test | Silicone | blocker | | OR | of the product |
| number | S | Bc | QBc | (g/mol) | OR |
| 1 | Silicone | Bc1 | 0.005 | 11 400 | 154 |
| | S1 | | | | |
| 2 | Silicone | | 0.005 | 8300 | 112 |
| | S2 | | | | |
| 3 | Silicone | | 0.005 | 16 000 | 215 |
| | S3 | | | | |
| 4 | Silicone | | 0.005 | 11 200 | 152 |
| | S4 | | | | |
| 4 | Silicone | | 0.005 | 13 200 | 178 |
| | S5 | | | | |

The results show that the process of the invention is versatile and can be used on all types of silicone, including mixtures of silicone and silicones comprising fillers.

### Example 3: Influence of the Nature of the Chain Blocker Bc on the Process of the Invention

The protocol from example 1 is implemented with the silicone S1 (30 g, 404 mmol of (Si—O) bonds in the silicone S1), HDBS (4400 ppm by weight, 0.132 g) as acid catalyst and a chain blocker Bc. The reaction medium is placed at room temperature for a duration of 24 h.

The nature of the chain blocker and the value QBc are indicated in the table below.

| | | | | Mₙ of | Degree of | |
|---|---|---|---|---|---|---|
| | | | | the | polymeriza- | |
| | Chain | | | product | tion of | Weight |
| Test | blocker | | mBc | OR | the product | percentage |
| number | Bc | QBc | (g) | (g/mol) | OR | of D₄ (%) |
| 1 | Bc1 | 0.005 | 0.38 | 11 400 | 154 | 1.4 |
| 2 | Bc2 | | 0.33 | 12 200 | 164 | 1.7 |
| 3 | Bc3 | | 0.27 | 11 300 | 152 | 2 |
| 4 | Bc4 | | 1.56 | 14 100 | 191 | 1.4 |
| 5 | — | — | | 28 000 | 377 | 1.3 |

This test was repeated, replacing the silicone S1 with an RTV2 silicone gel (silicone S3) manufactured by ELKEM. The other operating conditions remain unchanged compared to those mentioned above. Thus, it is carried out with the silicone S3 (30 g, 404 mmol of (Si—O) bonds in the silicone S3), HDBS (4400 ppm by weight, 0.132 g) as acid catalyst and a chain blocker Bc as indicated in the table below:

| | | | | | Degree of | |
|---|---|---|---|---|---|---|
| | | | | Mₙ Of the | polymeriza- | |
| | Chain | | | product | tion of | Weight |
| Test | blocker | | mBc | OR | the product | percentage |
| number | Bc | QBc | (g) | (g/mol) | OR | of D₄ (%) |
| 1 | Bc1 | 0.005 | 0.38 | 16 000 | 215 | 0.9 |
| 2 | Bc2 | | 0.33 | 14 400 | 194 | 0.9 |
| 3 | Bc3 | | 0.27 | 14 700 | 198 | 1.7 |

These tests demonstrate the versatility and the robustness of the process according to the present invention. Specifically, the nature of the chain blocker Bc has a limited effect on the number-average molecular weight (Mₙ) of the organopolysiloxane OR obtained according to the process of the invention. It is therefore possible to perform this process with various silicones S and various chain blockers Bc. In the context of this example, the product obtained according to the process of the invention has a percentage of D₄ of less than or equal to 2% by weight relative to the total weight of the organopolysiloxane OR.

### Example 4: Influence of the Amount of Chain Blocker Bc on the Process of the Invention

The protocol from example 1 is implemented with the silicone S1 (30 g, 404 mmol of (Si—O) bonds in the silicone S1), HDBS (4400 ppm by weight, 0.132 g) as acid catalyst and Bc1 as chain blocker. The reaction medium is placed at room temperature for a duration of 24 h.

The weight of Bc and the value QBc are indicated in the table below.

| | | | Mₙ of the | Degree of |
|---|---|---|---|---|
| | | | product | polymerization |
| Test | | mBc | OR | of the product |
| number | QBc | (g) | (g/mol) | OR |
| 1 | 0.000 | 0.00 | 28 000 | 377 |
| 2 | 0.002 | 0.15 | 17 700 | 239 |
| 3 | 0.003 | 0.23 | 15 200 | 205 |
| 4 | 0.005 | 0.38 | 11 400 | 154 |
| 5 | 0.007 | 0.53 | 9600 | 129 |
| 6 | 0.008 | 0.60 | 8000 | 108 |
| 7 | 0.009 | 0.68 | 7200 | 97 |
| 8 | 0.010 | 0.75 | 6500 | 87 |

In the context of each test (tests 1 to 8) of this example, the weight percentage of D₄ is less than 2% by weight relative to the total weight of the product OR.

This test was repeated, replacing the silicone S1 with an RTV2 silicone gel (silicone S3) manufactured by ELKEM. The other operating conditions remain unchanged compared to those mentioned above. Thus, it is carried out with the silicone S3 (30 g, 404 mmol of (Si—O) bonds in the silicone S3), HDBS (4400 ppm by weight, 0.132 g) as acid catalyst and a chain blocker Bc.

The weight of Bc and the value QBc are indicated in the table below.

| | | | Mₙ of the | Degree of | Weight |
|---|---|---|---|---|---|
| | | | product | polymerization | percentage |
| Test | | mBc | OR | of the product | of D₄ |
| number | QBc | (g) | (g/mol) | OR | (%) |
| 1 | 0.001 | 0.026 | 33 500 | 451 | 1.3 |
| 2 | 0.003 | 0.08 | 22 000 | 296 | 1.0 |
| 3 | 0.005 | 0.15 | 16 000 | 215 | 0.9 |
| 4 | 0.007 | 0.23 | 14 500 | 195 | 1.3 |
| 5 | 0.009 | 0.30 | 11 500 | 155 | 0.9 |

These two tests demonstrate the control of the number-average molecular weight (Mₙ) of the organopolysiloxane OR according to the process of the invention. The variation in the amount of material of the chain blocker Bc has an influence on the molecular weight of OR. It can be noted that the product obtained according to the process of the invention has a percentage of D₄ less than or equal to 1.3% by weight relative to the total weight of the organopolysiloxane OR.

### Example 5: Influence of the Amount of Acid on the Process of the Invention

The protocol from example 1 is implemented with the silicone S1 (30 g, 404 (Si—O) bonds in the silicone S1), HDBS (1100 ppm to 17 600 ppm by weight) as acid catalyst and a chain blocker Bc.

The value QBc and the molar amount of HDBS are indicated in the table below.

| | | | | | | Degree of | |
|---|---|---|---|---|---|---|---|
| | | | | | Mₙ of the | polymerization | Weight |
| | | Chain | | Amount | product | of the | percentage |
| Test | Silicone | blocker | | of HDBS (by | OR | product | of D4 |
| number | s | Bc | QBc | weight) | (g/mol) | OR | (%) |
| 1 | Silicone | Bc1 | 0.005 | 1100 ppm | 31 000 | 418 | n.d |
| | S1 | | | (0.033 g) | | | |
| 2 | | | | 2200 ppm | 21 600 | 291 | n.d |
| | | | | (0.066 g) | | | |
| 3 | | | | 4400 ppm | 11 400 | 154 | 1.7 |
| | | | | (0.132 g) | | | |
| 4 | | | | 6600 ppm | 8500 | 115 | 3.5 |
| | | | | (0.132 g) | | | |
| 5 | | | | 8800 ppm | 8100 | 109 | 4.5 |
| | | | | (0.132 g) | | | |
| 6 | | | | 17 600 ppm | 6500 | 88 | 11 |
| | | | | (0.132 g) | | | |

It can be noted that at a fixed amount of chain blocker QBc, when the amount of acid catalyst is increased, an increase in the percentage of D₄ is also observed.

Thus, the amount of acid catalyst involved in the reaction has an impact simultaneously on the reaction kinetics, the average molecular weights obtained and also on the amount of undesirable coproducts such as D₄.

With the aid of the information disclosed in the present invention, a person skilled in the art will know how to adapt these parameters to obtain, with the aid of the process of the present invention, a polyorganosiloxane OR with the desired number-average molecular weight Mₙ while controlling the content of cyclics.

### Example 6: Comparison with the Protocol of Patent Application JP2002348407A

Introduced into a 250-ml round-bottomed flask equipped with a magnetic stirrer were 20 g of PDMS S4, 47 g of toluene and 2.4 g of HDBS solution. After stirring for 1 hour at room temperature using a stirrer, the silicone tube was completely decomposed and dissolved. Next, a solution of 0.54 g of calcium hydroxide in 15 g of isopropanol was added for neutralization, and 50 g of water were added. The mixture obtained was stirred for 10 minutes. After standing for 30 minutes, a sample of the organic phase obtained is drawn off, diluted to suitable concentration, filtered and analyzed by size exclusion chromatography. The number-average molecular weight (Mₙ) of the organopolysiloxane of 11 000 g/mol is then obtained with an amount of undesirable coproducts such as octamethyltetrasiloxane (D₄) equal to 15% by weight relative to the total weight of the organopolysiloxane obtained.

### Example 7: Influence of the Nature of the Acid Catalyst

The protocol from example 1 is implemented with the silicone S1 (30 g, 404 mmol of (Si—O) bonds in the silicone S1), an acid catalyst (4400 ppm by weight) and a chain blocker Bc. The nature of acid catalyst and the weight of catalyst used are indicated in the table below.

| | | | | Weight | Mₙ of | | |
|---|---|---|---|---|---|---|---|
| | | | | of the | the | Degree of | |
| | Chain | | Nature of | acid | product | polymerization | Weight |
| Test | blocker | | the acid | catalyst | OR | of the | percentage |
| number | Bc | QBc | catalyst | (g) | (g/mol) | product OR | of D₄ (%) |
| 1 | Bc1 | 0.005 | — | — | 70 000 | 943 | — |
| 2 | | | HDBS | 0.132 | 11 400 | 154 | 1.3 |
| 3 | | | Tri- | 0.061 | 9800 | 132 | 3.0 |
| | | | fluoro- | | | | |
| | | | methane- | | | | |
| | | | sulfonic | | | | |
| | | | acid | | | | |
| | | | (CAS | | | | |
| | | | 1493-13-6) | | | | |

It can be noted that tests 2 and 3 have satisfactory results within the meaning of the present invention. However, it may be noted that trifluoromethanesulfonic acid results in 3% by weight of D₄ relative to the total weight of the organopolysiloxane OR.

In contrast, 4-dodecylbenzenesulfonic acid (CAS 121-65-3) exhibits a satisfactory implementation of the process of the present invention as has already been shown in the preceding examples.

### Example 8: Influence of the Reaction Time on the Process of the Invention

The protocol from example 1 is implemented with the silicone S1 (30 g, 404 mmol of (Si—O) bonds in the silicone S1), HDBS (4400 ppm by weight, 0.132 g) as acid catalyst and a chain blocker Bc.

The value QBc and the reaction time are indicated in the table below.

| | | | | Mₙ of the | Degree of | |
|---|---|---|---|---|---|---|
| | Chain | | | product | polymerization | Weight |
| Test | blocker | | Reaction | OR | of the product | percentage |
| number | Bc | QBc | time (h) | (g/mol) | OR | of D₄ (%) |
| 1 | Bc1 | 0.005 | 0 | 70 000 | 943 | 0.06 |
| 2 | | | 2 | 32 200 | 434 | 0.2 |
| 3 | | | 4 | 22 400 | 302 | 0.2 |
| 4 | | | 6 | 16 800 | 226 | 0.3 |
| 5 | | | 8 | 14 500 | 195 | 0.40 |
| 6 | | | 10 | 13 000 | 175 | 0.5 |
| 7 | | | 24 | 11 400 | 154 | 1.3 |

These tests demonstrate that the reaction time also makes it possible to control the number-average molecular weight Mₙ of the polyorganosiloxane OR obtained according to the process of the invention.

### Example 9: Influence of the Temperature on the Process of the Invention

The protocol from example 1 is implemented with the silicone S1 (30 g, 404 mmol of (Si—O) bonds in the silicone S1), HDBS (4400 ppm by weight, 0.132 g) as acid catalyst and a chain blocker Bc.

The table below indicates the temperature, the degree of polymerization of the product OR and the weight percentage of D₄:

| | | | | Mₙ of the | Degree of |
|---|---|---|---|---|---|
| | Chain | | | product | polymerization |
| Test | blocker | | Temperature | OR | of the product |
| number | Bc | QBc | (° C.) | (g/mol) | OR |
| 1 | Bc1 | 0.005 | RT | 11 400 | 154 |
| 2 | | | 50 | 16 000 | 216 |
| 3 | | | 70 | 19 000 | 256 |
| 4 | | | 100 | 17 700 | 239 |

The temperature during the implementation of the process of the invention makes it possible to control the number-average molecular weight Mₙ of the polyorganosiloxane OR obtained according to the process of the invention.

### Example 10: Influence of the Content of Solvent on the Process of the Invention

The protocol from example 1 is implemented with the silicone S1 (30 g, 404 mmol of (Si—O) bonds in the silicone S1), HDBS (4400 ppm by weight, 0.132 g) as acid catalyst and a chain blocker Bc and toluene as solvent.

In this example, five tests with different volumes of solvents were carried out.

This example aims to study a possible influence on the volume of solvent introduced into the process of the invention.

The table below indicates the volume of solvent introduced into the various tests:

| | | | | Mₙ of the | Degree of |
|---|---|---|---|---|---|
| | Chain | | Volume of | product | polymerization |
| Test | blocker | | solvent | OR | of the product |
| number | Bc | QBc | (ml) | (g/mol) | OR |
| 1 | Bc1 | 0.005 | 120 | 11 400 | 154 |
| 2 | | | 60 | 10 600 | 143 |
| 3 | | | 30 | 13 100 | 177 |
| 4 | | | 15 | 13 600 | 183 |
| 5 | | | 0 | 15 200 | 205 |

The amount of solvent introduced during the implementation of the process of the invention has a small influence on the variation of the number-average molecular weight Mₙ of the polyorganosiloxane OR obtained according to the process of the invention. Furthermore, in the same example, the weight percentage of D₄ by weight relative to the total weight of the product OR is less than or equal to 2% for each of the tests.

### Example 11: Reuse of the Silicone S2 Depolymerized to Organopolysiloxane OR in a New RTV2 Formulation

In the context of this example, the ability to use the functional organopolysiloxane OR (obtained under the conditions of test 1 of example 2) to prepare an RTV2 gel was tested. The recycled product OR from example 2, test 1 comprising vinyl functions was thus used in combination with a crosslinker of poly(methylhydrosiloxane)-co-poly(dimethylsiloxane) type where [Si—H]/[Si-vinyl]=2.25. In order to obtain this RTV2 gel, the hydrosylilation reaction was carried out in the presence of a Karstedt catalyst (275 ppm of a 2% Pt solution) and of 1-ethynylcyclohexanol used as moderator ([1-ethynylcyclohexanol]/[Pt]=14.6 ppm). Next, the reaction mixture was mixed, degassed and crosslinked for 4 h at 70° C.

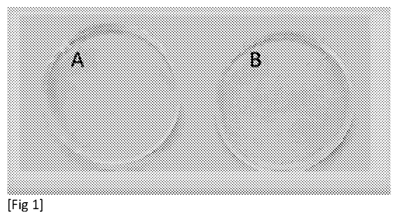

The appended FIG. 1 illustrates a photograph of the RTV2 gel obtained under the conditions of this example. This RTV2 formulation was prepared on two occasions under the same conditions and each of these tests has similar physical characteristics. Specifically, the RTV2 gel obtained during the first test has a degree of swelling of 280% and a fraction of extractables of 10% while the RTV2 gel obtained during the second test has a degree of swelling of 285% and a fraction of extractables of 10%.

Therefore, this example demonstrates that the organopolysiloxanes OR obtained according to the process of the invention can be used in formulations to obtain silicone gels of RTV2 type. In view of the information disclosed in the present invention and more particularly in this example, a person skilled in the art will know how to adapt the operating conditions in order to use the organopolysiloxanes obtained according to the process of the invention in other silicone formulations (HTV, RTV1, LSR).

1. A method of preparing organopolysiloxanes OR, the method comprising conducting a reaction for depolymerization of at least one silicone S in the presence:
of an acid catalyst chosen from benzenesulfonic acid derivatives of formula (VIa), alone or as mixtures: 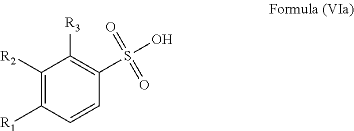
wherein either R₁ and R₂ represent a hydrogen atom and R₃=CₙH₂ₙ₊₁ where 5≤n≤20,
or R₁ and R₃ represent a hydrogen atom and R₂=CₙH₂ₙ₊₁ where 5≤n≤20,
or else R₂ and R₃ represent a hydrogen atom and R₁=CₙH₂ₙ₊₁ where 5≤n≤20,
and of at least one chain blocker Bc having at least one siloxane function.

2. The method as claimed in claim 1, wherein the acid catalyst is chosen from benzenesulfonic acid derivatives of formula (VIb), alone or as mixtures: 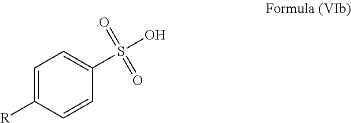
with R=CₙH₂ₙ₊₁ where 5≤n≤20.

3. The method as claimed in claim 1, wherein the chain blocker Bc is chosen from the compounds of formula (IV): 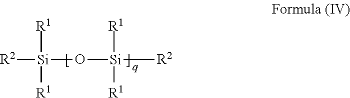
wherein:
R₁, which is identical or different, represents:
a linear or branched alkyl group comprising from 1 to 12 carbon atoms, optionally substituted with a heteroatom O, N, S or a halide,
an alkenyl group comprising from 2 to 6 carbon atoms,
a cycloalkyl group of from 5 to 10 carbon atoms, optionally substituted with a heteroatom O, N, S or a halide,
a C₆-C₁₈ aryl group,
a hydroxy group, or
a hydrogen,
R₂, which may be identical or different, represents:
an alkenyl group comprising from 2 to 6 carbon atoms,
a hydroxy group,
a linear or branched alkyl group comprising from 1 to 12 carbon atoms, optionally substituted with at least one heteroatom O, N, S or a halide, or
a hydrogen;
and q is an integer from 1 to 50.

4. The method as claimed in claim 1, wherein the amount of chain blocker Bc used in the method is at least about 10⁻⁴ mol per mole of (Si—O) bonds in the silicone S.

5. The method as claimed in claim 1, wherein the amount of acid catalyst is from about 0.001% to about 1% by weight relative to the weight of silicone S.

6. The method as claimed in claim 1, wherein the organopolysiloxane OR has a number-average molecular weight, denoted Mₙ, of from about 500 g/mol to about 300,000 g/mol.

7. The method as claimed in claim 1, wherein the content of cyclic organopolysiloxanes is less than about 5% by weight relative to the total weight of organopolysiloxanes OR.

8. The method as claimed in claim 1, wherein the reaction is carried out at a temperature of from about 0° C. to about 100° C.

9. The method as claimed in claim 1, wherein the reaction is carried out in the presence of a nonpolar solvent.

10. The method as claimed in claim 1, wherein the weight ratio, weight of silicone S to weight of solvent used, is from about 0.01 to about 15.

11. The method as claimed in claim 1, wherein the method further comprises a step of neutralizing the acid catalyst, carried out by adding a base to the reaction medium or by thermal degradation of the acid catalyst.

12. The method as claimed in claim 1, wherein the method comprises the following steps:
1) carrying out the process of preparing the organopolysiloxanes OR, by a reaction for depolymerization of at least one silicone S in the presence of an acid catalyst and of at least one chain blocker Bc having at least one siloxane function;
2) neutralizing the acid catalyst mentioned in the preceding step by adding a base to the reaction medium or by thermal degradation of the acid catalyst; and
3) filtering the reaction medium obtained on conclusion of step 2.

13. A silicone formulation comprising an effective amount of the organopolysiloxane OR as claimed in claim 1, wherein the formulation is prepared for being used in the field of cosmetics, health, household products, technical industrial formulations, transportation such as motor vehicle or aviation transportation, or the energy field.

14. A process of preparing silicone S, notably silicone oils, resins, gums or elastomers, the process comprising the following steps:
1) carrying out the method of preparing the organopolysiloxane OR as claimed in claim 1; and
2) preparing the silicone S from the organopolysiloxane OR obtained in step 1).

15. The process as claimed in claim 14, wherein step 2 is carried out by a polyaddition or polycondensation reaction, of cationic mechanism or of radical mechanism.

16. A silicone S obtained by the process as claimed in claim 14, wherein the silicone S is formulated for being used in the field of cosmetics, health, household products, technical industrial formulations, transportation such as motor vehicle or aviation transportation, or the energy field.

17. The method as claimed in claim 1, wherein n in the Formula (VIa) is 10≤n≤20 when R₃=CₙH₂ₙ₊₁.

18. The method as claimed in claim 1, wherein n in the Formula (VIa) is 10≤n≤20. when R₂=CₙH₂ₙ₊₁.

19. The method as claimed in claim 1, wherein n in the Formula (VIa) is 10≤n≤20. when R₁=CₙH₂ₙ₊₁.

20. The method as claimed in claim 2, wherein n in the Formula (VIb) is 10≤n≤20. when R=CₙH₂ₙ₊₁.

21. The method as claimed in claim 3, wherein when R₁ represents a linear or branched alkyl group, it comprises 1 to 8 carbon atoms.

22. The method as claimed in claim 3, wherein when R₂ is an alkenyl group it is a vinyl.

23. The method as claimed in claim 3, wherein when R₂ is a linear or branched alkyl group, it comprises 1 to 5 carbon atoms.

24. The method as claimed in claim 3, wherein R₂ is a linear or branched alkyl group, it is substituted with a fluorine atom.

25. The method as claimed in claim 24, wherein R₂ is substituted with 1 to 10 fluorine atoms.

26. The method as claimed in claim 3, wherein q is an integer from 1 to 20.

27. The method as claimed in claim 26, wherein q is an integer from 1 to 10.

28. The method as claimed in claim 4, wherein the amount of chain blocker Bc is from about 10⁻³ to about 5×10⁻¹ mol per mole of (Si—O) bonds in the silicone S.

29. The method as claimed in claim 4, wherein the amount of chain blocker Bc is from about 10⁻³ to about 10⁻² mol per mole of (Si—O) bonds in the silicone S.

30. The method as claimed in claim 4, wherein the amount of chain blocker Bc is from about 3×10⁻³ to about 6×10⁻¹ mol per mole of (Si—O) bonds in the silicone S.

31. The method as claimed in claim 5, wherein the amount of acid catalyst is from about 0.05% to about 1% relate to the weight of silicone S.

32. The method as claimed in claim 5, wherein the amount of acid catalyst is from about 0.1% to about 1% relate to the weight of silicone S.

33. The method as claimed in claim 6, wherein number-average molecular weight Mn is from about 1,000 g/mol to about 150,000 g/mol.

34. The method as claimed in claim 6, wherein number-average molecular weight Mn is from about 1,000 g/mol to about 70,000 g/mol.

35. The method as claimed in claim 6, wherein number-average molecular weight Mn is from about 2,500 g/mol to about 30,000 g/mol.

36. The method as claimed in claim 7, wherein the content of the cyclic organopolysiloxanes is less than or equal to about 3% by weight.

37. The method as claimed in claim 7, wherein the content of the cyclic organopolysiloxanes is less than or equal to about 2% by weight.

38. The method as claimed in claim 7, wherein the content of the cyclic organopolysiloxanes is less than or equal to about 1.5% by weight.

39. The method as claimed in claim 8, wherein the reaction temperature is from about 0° C. to about 50° C.

40. The method as claimed in claim 8, wherein the reaction temperature is from about 10° C. to about 35° C.

41. The method as claimed in claim 8, wherein the weight ratio is from about 0.1 to about 5.

42. The method as claimed in claim 8, wherein the weight ratio is from about 0.1 to about 2.
